(19) United States
(12) Patent Application Publication
(10) Pub. No.: US 2026/0140332 A1
(43) Pub. Date: May 21, 2026

(54) ACTIVE OPTICAL CABLE BUNDLING

(71) Applicant: AFL Telecommunications LLC, Duncan, SC (US)

(72) Inventor: Nikhil Angra, Bellevue, WA (US)

(21) Appl. No.: 19/122,490

(22) PCT Filed: Oct. 24, 2023
(86) PCT No.: PCT/US2023/035788

§ 371 Date: Apr. 18, 2025

Related U.S. Application Data
(60) Provisional application No. 63/419,086, filed on Oct. 25, 2022.
(60) Provisional application No. 63/455,422, filed on Mar. 29, 2023.

(51) Int. Cl. G02B 6/42; G02B 6/255; G02B 6/44

(52) U.S. Cl. CPC G02B 6/4202; G02B 6/255; G02B 6/4249; G02B 6/4285; G02B 6/4436; G02B 6/4446; G02B 6/4448; G02B 6/44715; G02B 6/4482

(57) ABSTRACT

Methods for assembling an active optical cable are provided. A method includes breaking out a plurality of optical fiber legs from a cable jacket of a fiber optic cable such that the optical fiber legs extend from an end of the cable jacket, wherein each of the optical fiber legs includes at least one optical fiber. The method further includes terminating the optical fibers of the optical fiber legs with active connectors. The method further includes connecting converter components to the active connectors. The method further includes simultaneously testing at least a portion of the transceiver optical engines of the active optical cable.

### CROSS-REFERENCE TO RELATED APPLICATIONS

The present application claims priority to U.S. Provisional Ser. No. 63/419,086 filed on Oct. 25, 2022 and U.S. Provisional Ser. No. 63/455,422 filed on Mar. 29, 2023, the disclosures of both of which are incorporated by reference herein in their entireties.

### FIELD

The present disclosure relates generally to active optical cables, and more particularly to improved methods and apparatus for bundling active optical cables.

### BACKGROUND

Active optical cables (AOCs) are deployed in fiber optic networks as a stand-alone cable connection. When deploying AOCs in volume across global networks, the process is inefficient to deploy, is a change in methodology, leads to significant waste, adds to storage costs and has a large carbon footprint during shipping, deploying and de-commissioning.

For example, when a single AOC is shipped to a customer site, it needs to be opened individually, the ports to connect to need to be determined, and the link needs to be made individually. It is a repetitive process leading to increased labor cost, increased time to deploy and delays in data center commissioning. Deployment of AOCs in raceways can also lead to additional infrastructure costs.

Further, while the use of standard trunk cables in raceways is a standard methodology for cabling installs, AOC installation requires specific handling. Single AOC deployment increases the risk of damage on site. Alternate methods to terminate and test AOCs on site are needed for standardizing and commissioning links.

Still further, AOCs arrive on customer sites in individual packages that needs to be disposed of causing increased waste at site. Additionally, bulky pallets arriving at site need to be stored and the inventory managed per location. The shipping costs for pallets increases with single AOCs, raceway utilization is reduced, and significant waste is created from the cable jackets during de-commissioning and refresh cycles.

Finally, single transceiver-to-transceiver AOC packaging also leads to the non-availability of specific length SKUs causing installation delays.

Accordingly, improved methods and apparatus for bunding AOC's which address one or more of the above-described deficiencies would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a method for assembling an active optical cable is provided. The method includes breaking out a plurality of optical fiber legs from a cable jacket of a fiber optic cable such that the optical fiber legs extend from an end of the cable jacket, wherein each of the optical fiber legs includes at least one optical fiber. The method further includes terminating the optical fibers of the optical fiber legs with active connectors. The method further includes connecting converter components to the active connectors. The method further includes simultaneously testing at least a portion of the converter components of the active optical cable.

In accordance with another embodiment, a method for assembling an active optical cable is provided. The method includes breaking out a plurality of optical fiber legs from a cable jacket of a fiber optic cable such that the optical fiber legs extend from an end of the cable jacket, wherein each of the optical fiber legs includes at least one optical fiber. The method further includes terminating a plurality of optical fiber pigtails with active connectors. The method further includes connecting the active connectors to converter components. The method further includes testing the converter components. The method further includes selectively splicing one or more of the optical fiber pigtails to one or more of the optical fiber legs.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a schematic illustration of a fiber optic cable with a plurality of optical fiber legs broken out from a cable jacket in accordance with embodiments of the present disclosure;

FIG. 2 is a perspective view of an active connector terminating a plurality of optical fibers of a fiber optic cable in accordance with embodiments of the present disclosure;

FIG. 3 is a perspective view of a converter component, in this case a transceiver optical engine, connected to an active connector terminating a plurality of optical fibers of a fiber optic cable in accordance with embodiments of the present disclosure;

FIG. 4 is a schematic view of an assembled active optical cable in accordance with embodiments of the present disclosure;

FIG. 5 is a flow chart illustrating a method for assembling an active optical cable in accordance with embodiments of the present disclosure;

FIG. 6 is a perspective view of an active connector terminating a plurality of optical fibers of an optical fiber pigtail in accordance with embodiments of the present disclosure;

FIG. 7 is a perspective view of a converter component, in this case a transceiver optical engine, connected to an active connector terminating a plurality of optical fibers of an optical fiber pigtail in accordance with embodiments of the present disclosure;

FIG. 8 is a schematic view of an assembled active optical cable in accordance with embodiments of the present disclosure;

FIG. 9 is a flow chart illustrating a method for assembling an active optical cable in accordance with embodiments of the present disclosure; and

FIG. 10 is a schematic of a computing device utilized in methods in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure is directed to improved active optical cable, also referred to herein as active optical cable bundles, as well as improved methods for assembling active optical cables, also referred to herein as bundling.

Bundles and bundling in accordance with the present disclosure addresses one or more of the above-described deficiencies. In accordance with the present disclosure, active optical cables can advantageously be installed for large data center builds in an operationally cost efficient and environmentally efficient manner.

In accordance with embodiments of the present disclosure, active optical cable bundles and bundling in accordance with the present disclosure reduces weight, waste, and storage needs when assembling and shipping active optical cables to customers. Rather than bundle individual cables (each of which includes a transceiver on an end thereof) together, a single cable is assembled, individual legs are broken out, and the legs are then terminated.

Exemplary advantages of bundles and bundling in accordance with the present disclosure include one or more of the following: direct cradle-to-gate carbon footprint reduction by up to 80% of current product (e.g. one jacket vs multiple (such as 4 or 8) jackets); reduced shipping costs due to reduction in bundle weight, such as by 35%; significant increase in raceway utilization due to reduced cable diameter; multiple options with passive and active connectors for eliminating dedicated AOC raceways; increased product availability due to partially assembled kits that can be delivered “just-in-time”; product offering extension to serve customers with 100 G, 200 G, 400 G, and 800 G product availability; termination and kitting options which extend the reach of the AOC product beyond 20 m up to 50+ meter applications; proper in region material (jacket) flammability rating (CMR, CMP, PLM, LSZH, etc . . . ); tags, such as NFC adders, allow for quick product identification for install and refresh cycles; positive de-commissioning impact on waste; and/or reduced product carbon footprint.

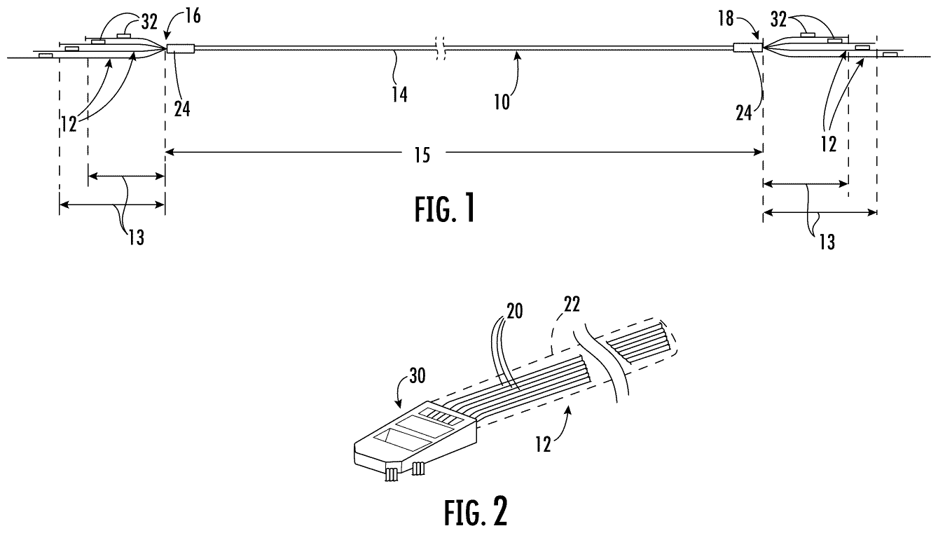

Referring now to FIGS. 1 through 4, embodiments of active optical cable components during assembly thereof are provided. FIG. 1 illustrates an optical fiber cable 10 prior to complete assembly as an active optical cable. Optical fiber legs 12 of the optical fiber cable 10 may be broken out, or furcated, from a cable jacket 14 of the cable 10, as shown. Specifically, cable jacket 14 may have a length 15 which extends from a first end 16 to a second end 18. Each optical fiber leg 12 may extend from one or both ends 16, 18 of the jacket 14. In some embodiments, portions of the jacket 14 may be removed such that the legs 12 extend therefrom, such that the resulting jacket 14 after removal of such portions includes the ends 16, 18. In other embodiments, jacket 14 may be constructed with legs 12 extending therefrom.

Jacket 14 may be formed from any suitable materials. In exemplary embodiments, jacket 14 may be formed from flame-retardant materials. For example, in some embodiments, back may have a CMR or CMP rating. In other embodiments, jacket 14 may be formed from a low smoke zero halogen material. In other embodiments, PVC or HDPE may be utilized. In exemplary embodiments, the cable 10 is selected for assembly in accordance with the present disclosure based on the jacket material as discussed above, such that the resulting active optical cable is customized to client requirements with respect to such variable.

Each leg 12 may include one or more optical fibers 20. Each optical fiber may extend through and protrude from the ends 16, 18 of the jacket 14. Each optical fiber 20 may be a single mode optical fiber, multimode optical fiber, or other suitable optical fiber. Each optical fiber may be a 250 micron optical fiber, 200 micron optical fiber, or have another suitable diameter. Optical fibers 20 within a leg 12 may be loose optical fibers, ribbonized optical fibers, or intermittently-bonded optical fibers. In exemplary embodiments, the cable 10 is selected for assembly in accordance with the present disclosure based on the optical fiber type, diameter, and/or ribbon type as discussed above, such that the resulting active optical cable is customized to client requirements with respect to such variables.

Each leg 12 may further include one or more buffer tubes 22. A buffer tube 22 may surround the one or more optical fibers 20 of an optical fiber leg 12, such that the optical fiber(s) 20 extend through the buffer tube 22. Further, in some embodiments, a buffer tube 22 may extend through and protrude from the ends 16 and/or 18 of the jacket 14. Alternatively (or additionally), buffer tubes 22 may be provided on the optical fibers 20 extending from ends 16 and/or 18 during breaking out of the legs 12.

In some embodiments, a broken out fiber optic cable 10 may further include one or more breakout kits 24, which may be or include furcation tubes.

Breakout kits 24 may be connected to the ends 16 and/or 18 of the jacket 14 and provide a transition for the optical fibers 20 and legs 12 from the jacket 14. In exemplary embodiments, breaking out of the legs 12 from the cable 10 may include providing one or more breakout kits 24 on the ends 16 and/or 18 and directing the legs 12 through and from the kits 24.

Referring now to FIG. 2, one or more of the optical fibers 20 of a fiber optic cable 10 may be terminated with an active connector 30. When terminated, each active connector 30 may be connected to one or more optical fibers of a leg 12. One or more active connectors 30 may terminate each leg 12. In some embodiments, active connectors 30 may terminate all of the optical fibers 20 in a cable 10.

Alternatively, some optical fibers 20 may be terminated by active connectors 30, while others are terminated by passive connectors. Further, with respect to each optical fiber 20, in some embodiments an optical fiber 20 may be terminated at both ends (e.g. the ends protruding from ends 16 and 18 of jacket 14) by active connectors 30, while in other embodiments an optical fiber 20 may be terminated at one end (e.g. the end protruding from end 16 or 18 of jacket 14) by an active connector 30 and terminated at the other end (e.g. the end protruding from the other of end 16 or 18 of jacket 14) by a passive connector. In still other embodiments, an optical fiber 20 may be terminated at both ends (e.g. the ends protruding from ends 16 and 18 of jacket 14) by passive connectors.

Examples of suitable active connectors include, for example, PRIZM® LightTurn connectors, although other suitable active connectors may be utilized.

Examples of suitable passive connectors include SC connectors, LC connectors, MPO connectors, etc.

In some embodiments, each of the optical fiber legs 12 may be customized, such as to client requirements for a particular application. For example, each leg 12 may have an end length 13. Length 13 may be measured from an end 16 or 18 of the jacket 14 along the leg 12 in a direction away from the jacket 14 to an end of the leg 12 (e.g. an end of the optical fibers 20 or an end of the buffer tube 22). The length 13 of each leg 12 of the plurality of legs 12 in a cable 10 may be customized to a particularly desired number based on client requirements, and the length 13 of each leg 12 may be the same as or different from one or more other legs 12 in the cable 10. Notably, the end length 13 of a leg 12 extending from end 16 may be the same as or different from the end length 13 of the same leg 12 extending from end 18.

Further, each leg 12 may have a specified number of optical fibers 20. The number of optical fiber 20 in each leg may be the same as one or more other legs 12 and/or may be different from one or more other legs. In some embodiments, a leg 12 may include 2 fibers, 4 fibers, 16 fibers, 32 fibers, 64 fibers, 128 fibers, 256 fibers, or another suitable number of fibers.

Further, each leg 12 may be terminated with one or more connectors as discussed above, and the type of connector (active connector 30 or passive connector, type of active or passive connector, etc.) may be customized based on client requirements. For example, each leg 12 may be terminated on the opposing ends thereof with connectors, and each connector may be active or passive.

Further, one or more tags 32 may be provided on one or more of the legs 12, and the tag 32 may be customized based on client requirements. For example, each tag 32 may be an electronic tag (e.g. an NFC tag, an RFID tag, etc), a written label, or another suitable tag form which stores and provides identification information for the leg 12.

In exemplary embodiments, the legs 12 are each customized based on at least one of length 13, connector type, or tag requirement, such that the resulting active optical cable is customized to client requirements with respect to such variables. Notably, each customized leg 12 with an active optical cable may have one or more characteristics (as discussed above) that are the same as or different from one or more other customized legs 12 with the same active optical cable.

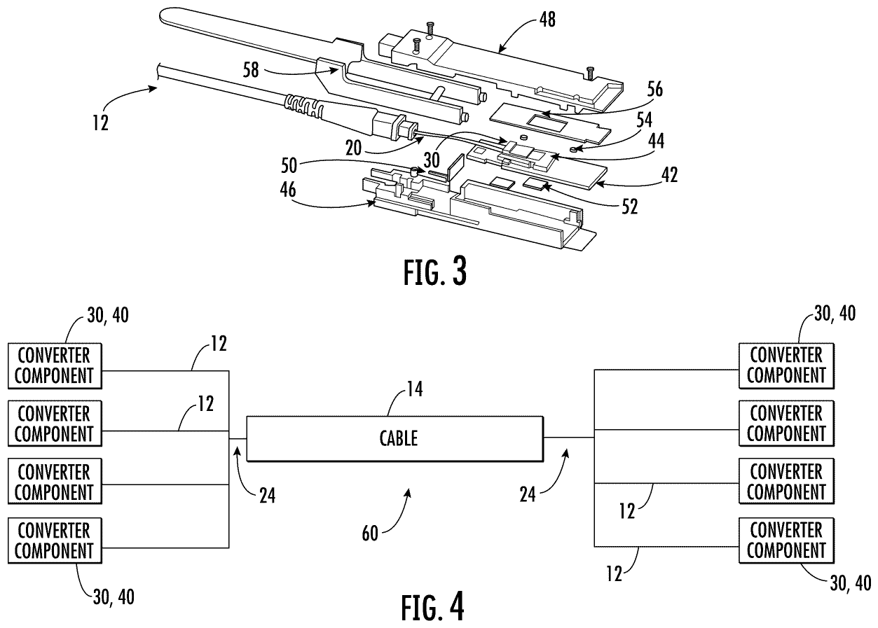

Referring now to FIG. 3, the active connectors 30 may be connected to converter components 40. In some embodiments, the converter components 40 may be transceiver optical engines 40. The transceiver optical engine 40 may be a components of a transceiver which converts optical signals to electrical signals. An optical engine 40 may include, for example, a circuit board 42 and lens array 44.

Optical engine 40 may further include a housing which contains the circuit board 42 and lens array 44. Housing may include, for example, a bottom cover 46 and a top cover 48. Additional components of the optical engine 40 may include, for example, a spring 50, a thermal pad 52, a gasket 54, a de-EMI pad 56, and a latch 58.

In alternative embodiments, a converter component 40 may be or include a chiplet that includes optical and/or electrical circuitry. In other alternative embodiments, a converter component 40 may be or include a laser or laser assembly. In still other alternative embodiments, other suitable active optical cable components which generally provide mechanisms for converting optical signals to other suitable signals such as electrical signals, laser signals, audio signals, etc. may be considered to be converter components 40.

In some embodiments, each of the converter components 40 may be customized, such as to client requirements for a particular application. For example, each of the transceiver optical engines 40 may be selected from one of a 100 G transceiver optical engine, a 200 G transceiver optical engine, a 400 G transceiver optical engine, a 800 G transceiver optical engine, or another suitable transceiver optical engine. Further, other suitable characteristics of each transceiver optical engine 40 may be customized, such as to client requirements for a particular application.

In exemplary embodiments, the legs 12 are each customized based on selected converter components 40, such that the resulting active optical cable is customized to client requirements with respect to such variables. Notably, each customized leg 12 within an active optical cable may have one or more characteristics (as discussed above) that are the same as or different from one or more other customized legs 12 with the same active optical cable.

FIG. 4 illustrates an assembled active optical cable 60 having the various components as discussed herein.

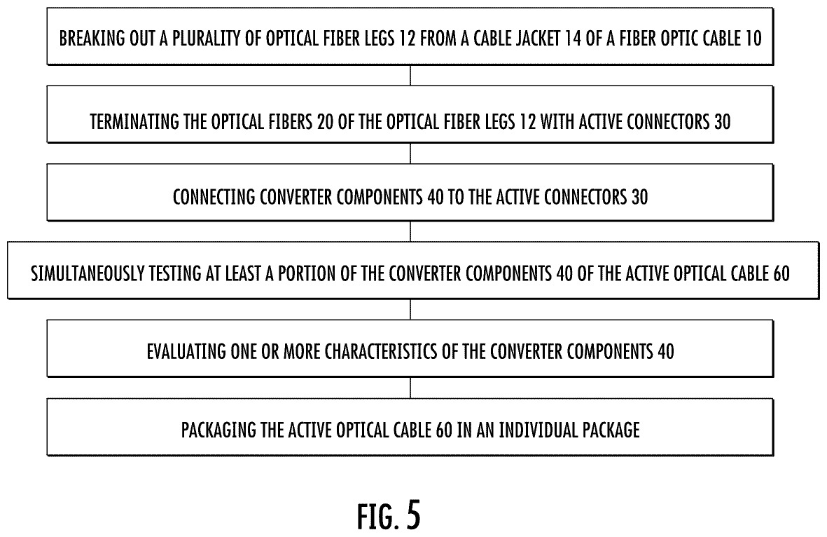

Referring now to FIG. 5, at least a portion of the converter components 40, such as in some embodiments all of the converter components 40 of an active optical cable 60, may be simultaneously tested. For example, in some embodiments, all of the converter components 40 of one or more legs 12 may be simultaneously tested.

Such simultaneous testing may advantageously significantly reduce the time needed for qualifying an assembled active optical cable 60.

In exemplary embodiments, such testing may be performed after connecting the converter components 40 to the active connector 30.

Such testing may facilitate evaluation of the status of certain converter components 40 characteristics. For example, one or more of fiber 20 operational status, converter components 40 status, or polarity status (such as in the case of the transceiver optical engines 40) that were simultaneously tested may be evaluated.

Fiber 20 operational status may include, for example, characteristics which indicate that the fiber 20 is not broken and/or meets suitable attenuation requirements.

Converter component 40 status may include, for example, characteristics which indicate that the converter component 40 is operational and not broken. Polarity status includes, for example, characteristics which indicate that the polarity status of the transceiver optical engine 40 is correct.

In exemplary embodiments, the testing and/or evaluating steps may be performed with a computing system 600, as discussed herein with reference to FIG. 11.

In some embodiments, an active optical cable 60 may be packaged in an individual package. Such packaging may, for example, occur after breaking out, terminating, connecting, testing, and/or evaluating of the active optical cable 60.

Packaging of an active optical cable 60 in an individual package may advantageously significantly reduce the time needed for finalizing assembly of the active optic cable 60 for shipment to a customer.

In exemplary embodiments, the breaking out, terminating, connecting, testing, and/or evaluating steps may occur in a single factory/facility or series of factories/facilities prior to shipment to a customer, thus advantageously addressing one or more of the above-described issues with known assembly procedures.

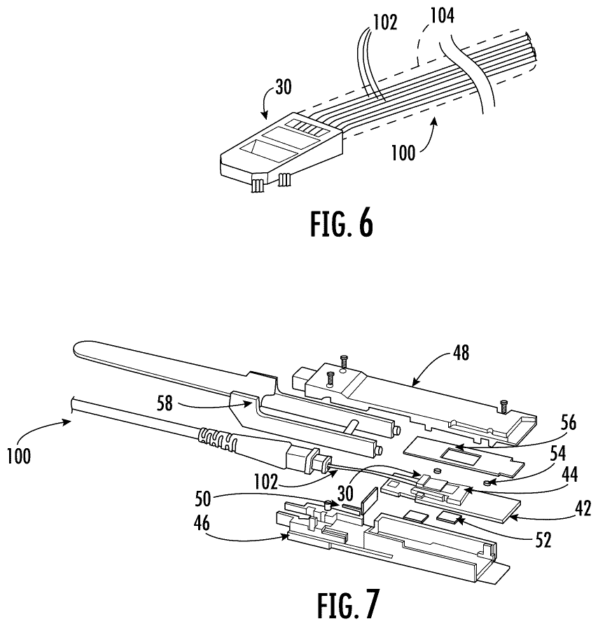

Referring now to FIGS. 6 through 9, alternative embodiments for assembling active optical cables are provided. In such embodiments, optical fiber pigtails 100 are utilized, and the optical fibers 102 of the pigtails are spliced to the optical fibers 20 to form the active optical cables 60. A pigtail 100 may include one or more optical fibers 102, one or more buffer tubes 104 surrounding the optical fibers 102, and other components as discussed herein.

Referring now to FIG. 6, one or more of the optical fibers 102 of an optical fiber pigtail 100 may be terminated with an active connector 30, as discussed herein. When terminated, each active connector 30 may be connected to one or more optical fibers 102 of the pigtail 100. One or more active connectors 30 may terminate each pigtail 100. In some embodiments, active connectors 30 may terminate all of the optical fibers 102 in a pigtail 100. Alternatively, some optical fibers 102 may be terminated by active connectors 30, while others are terminated by passive connectors.

Referring now to FIG. 7, the active connectors 30 may be connected to converter components 40, as discussed herein. In exemplary embodiments, the pigtails 100 are each customized based on selected converter components 40, such that the resulting active optical cable is customized to client requirements with respect to such variables. Notably, each customized pigtail 100 with an active optical cable may have one or more characteristics (as discussed above) that are the same as or different from one or more other customized pigtails 100 with the same active optical cable.

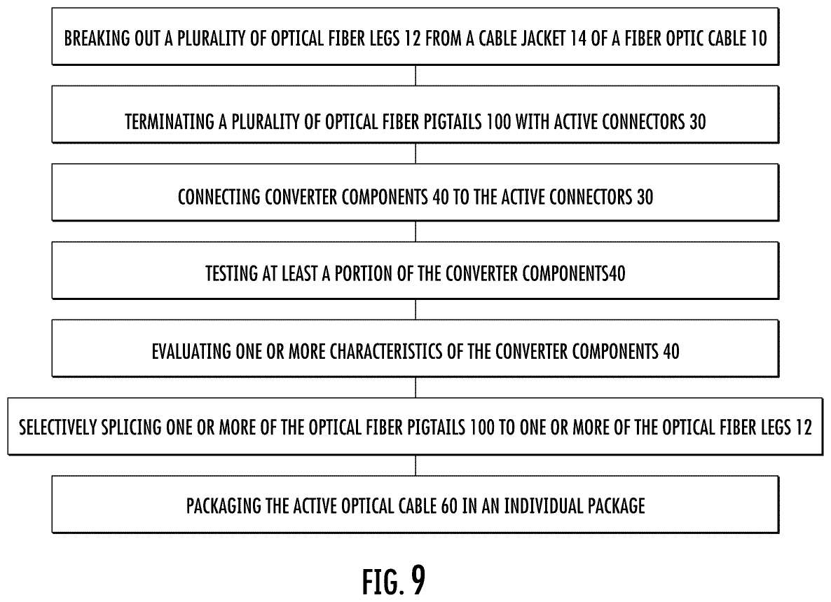

Referring now to FIG. 9, at least a portion of the converter components 40 may be tested, such as simultaneously tested, as discussed herein. Such testing may occur prior to or after selective splicing of the pigtails 100 to the legs 12 as discussed herein.

Such testing may facilitate evaluation of the status of certain converter components 40 characteristics, as discussed herein.

In exemplary embodiments, the testing and/or evaluating steps may be performed with a computing system 600, as discussed herein with reference to FIG. 11.

Still referring to FIG. 9, one or more of the optical fiber pigtails 100 may be selectively spliced to legs 12 of the cable 10. Specifically, the optical fibers 102 of the pigtails 100 may be spliced to the optical fibers 20 of the legs 12. One or more pigtails 100 may be spliced to each leg 12. Pigtails 100 may be selected based on customization requirements with respect to the active connectors 30 and/or converter components 40 as discussed herein.

Notably, with respect to each optical fiber 20, in some embodiments an optical fiber 20 may be spliced at both ends (e.g. the ends protruding from ends 16 and 18 of jacket 14) to connect active connectors 30, while in other embodiments an optical fiber 20 may be spliced at one end (e.g. the end protruding from end 16 or 18 of jacket 14) to connect an active connector 30 and terminated at the other end (e.g. the end protruding from the other of end 16 or 18 of jacket 14) by a passive connector. In still other embodiments, an optical fiber 20 may be terminated at both ends (e.g. the ends protruding from ends 16 and 18 of jacket 14) by passive connectors.

In exemplary embodiments, the legs 12 are each customized based on at least one of length 13, connector type, or tag requirement, such that the resulting active optical cable is customized to client requirements with respect to such variables. Notably, each customized leg 12 with an active optical cable may have one or more characteristics (as discussed above) that are the same as or different from one or more other customized legs 12 with the same active optical cable.

In some embodiments, testing and/or evaluating of the active optical cable 60 as discussed above may occur after splicing as discussed above. Such testing and/or evaluating may occur in addition to or alternatively to pigtail 100 testing and/or evaluating.

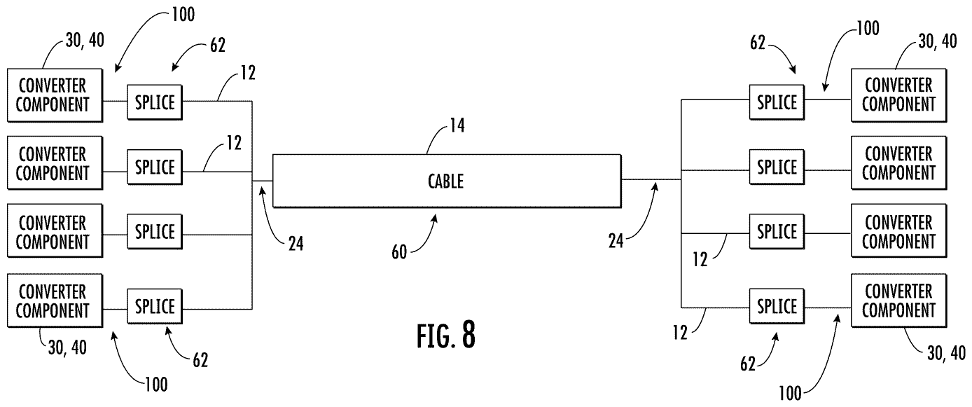

FIG. 8 illustrates an assembled active optical cable 60 having the various components as discussed herein, including splices 62 resulting from splicing as discussed herein.

In some embodiments, an active optical cable 60 may be packaged in an individual package. Such packaging may, for example, occur after breaking out, terminating, connecting, testing, evaluating, and/or splicing of the active optical cable 60. Packaging of an active optical cable 60 in an individual package may advantageously significantly reduce the time needed for finalizing assembly of the active optic cable 60 for shipment to a customer In exemplary embodiments, the breaking out, terminating, connecting, testing, evaluating, and/or splicing steps may occur in a single factory/facility or series of factories/facilities prior to shipment to a customer, thus advantageously addressing one or more of the above-described issues with known assembly procedures.

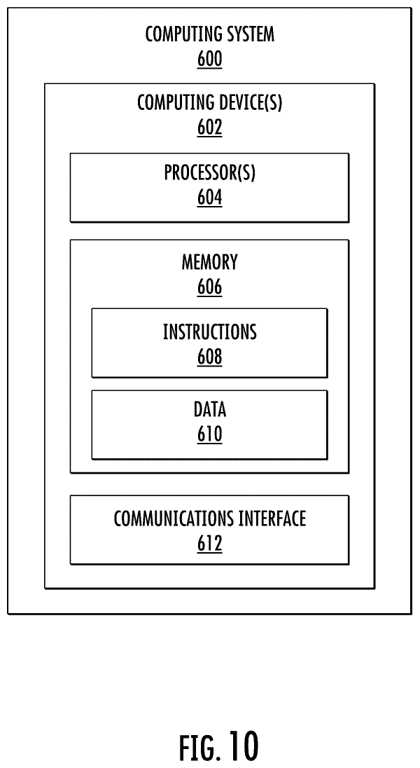

FIG. 10 provides a block diagram of an example computing system 600.

The computing system 600 can be used to implement the aspects disclosed herein.

The computing system 600 can include one or more computing device(s) 602. As shown in FIG. 10, the one or more computing device(s) 602 can each include one or more processor(s) 604 and one or more memory device(s) 606. The one or more processor(s) 604 can include any suitable processing device, such as a microprocessor, microcontroller, integrated circuit, logic device, or other suitable processing device. The one or more memory device(s) 606 can include one or more computer-readable media, including, but not limited to, non-transitory computer-readable medium or media, RAM, ROM, hard drives, flash drives, and other memory devices, such as one or more buffer devices.

The one or more memory device(s) 606 can store information accessible by the one or more processor(s) 604, including computer-readable or computer-executable instructions 608 that can be executed by the one or more processor(s) 604. The instructions 608 can be any set of instructions or control logic that when executed by the one or more processor(s) 604, cause the one or more processor(s) 604 to perform operations. The instructions 608 can be software written in any suitable programming language or can be implemented in hardware. In some embodiments, the instructions 608 can be executed by the one or more processor(s) 604 to cause the one or more processor(s) 604 to perform operations.

The memory device(s) 606 can further store data 610 that can be accessed by the processor(s) 604. For example, the data 610 can include sensor data such as engine parameters, model data, logic data, etc., as described herein. The data 610 can include one or more table(s), function(s), algorithm(s), model(s), equation(s), etc., according to example embodiments of the present disclosure.

The one or more computing device(s) 602 can also include a communications interface 612 used to communicate, for example, with the other components of the additive manufacturing system. The communications interface 612 can include any suitable components for interfacing with one or more network(s), including, for example, transmitters, receivers, ports, controllers, antennas, or other suitable components.

The technology discussed herein makes reference to computer-based systems and actions taken by and information sent to and from computer-based systems. It will be appreciated that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems.

Although specific features of various embodiments may be shown in some drawings and not in others, this is for convenience only. In accordance with the principles of the present disclosure, any feature of a drawing may be referenced and/or claimed in combination with any feature of any other drawing.

Further aspects of the invention are provided by one or more of the following embodiments:
A method for assembling an active optical cable, including breaking out a plurality of optical fiber legs from a cable jacket of a fiber optic cable such that the optical fiber legs extend from an end of the cable jacket, wherein each of the optical fiber legs includes at least one optical fiber. The method further includes terminating the optical fibers of the optical fiber legs with active connectors. The method further includes connecting converter components to the active connectors. The method further includes simultaneously testing at least a portion of the converter components of the active optical cable.

A method for assembling an active optical cable, including breaking out a plurality of optical fiber legs from a cable jacket of a fiber optic cable such that the optical fiber legs extend from an end of the cable jacket, wherein each of the optical fiber legs includes at least one optical fiber. The method further includes terminating a plurality of optical fiber pigtails with active connectors. The method further includes connecting the active connectors to converter components. The method further includes testing the converter components. The method further includes selectively splicing one or more of the optical fiber pigtails to one or more of the optical fiber legs.

A method in accordance with one or more embodiments disclosed herein, wherein each of the optical fiber legs comprises a buffer tube surrounding the at least one optical fiber of the optical fiber leg.

A method in accordance with one or more embodiments disclosed herein, wherein each of the optical fiber legs comprises a plurality of optical fibers.

A method in accordance with one or more embodiments disclosed herein, wherein the cable jacket is formed from a low smoke zero halogen material.

A method in accordance with one or more embodiments disclosed herein, wherein the cable jacket has a CMR or CMP rating.

A method in accordance with one or more embodiments disclosed herein, wherein the converter components are transceiver optical engines.

A method in accordance with one or more embodiments disclosed herein, further comprising selecting each of the transceiver optical engines, wherein each of the selected transceiver optical engines is selected from one of a 100 G transceiver optical engine, a 200 G transceiver optical engine, a 400 G transceiver optical engine, or a 800 G transceiver optical engine.

A method in accordance with one or more embodiments disclosed herein, wherein all of the converter components of the active optical cable are simultaneously tested.

A method in accordance with one or more embodiments disclosed herein, wherein all of the converter components of the optical fiber pigtails are simultaneously tested.

A method in accordance with one or more embodiments disclosed herein, wherein the selectively splicing step occurs after the testing step.

A method in accordance with one or more embodiments disclosed herein, further comprising customizing each of the plurality of optical fiber legs based on at least one of end length, number of optical fibers, connector type, or tag requirement.

A method in accordance with one or more embodiments disclosed herein, further comprising evaluating one or more of fiber operational status, converter component status, or polarity status of the at least a portion of the converter components.

A method in accordance with one or more embodiments disclosed herein, further comprising packaging the active optical cable in an individual package.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for assembling an active optical cable, the method comprising:
breaking out a plurality of optical fiber legs from a cable jacket of a fiber optic cable such that the optical fiber legs extend from an end of the cable jacket, wherein each of the optical fiber legs comprises at least one optical fiber;
terminating the optical fibers of the optical fiber legs with active connectors;
connecting converter components to the active connectors; and
simultaneously testing at least a portion of the converter components of the active optical cable.

2. The method of claim 1, wherein each of the optical fiber legs comprises a buffer tube surrounding the at least one optical fiber of the optical fiber leg.

3. The method of claim 1, wherein each of the optical fiber legs comprises a plurality of optical fibers.

4. The method of claim 1, wherein the cable jacket is formed from a low smoke zero halogen material.

5. The method of claim 1, wherein the cable jacket has a CMR or CMP rating.

6. The method of claim 1, wherein the converter components are transceiver optical engines.

7. The method of claim 6, further comprising selecting each of the transceiver optical engines, wherein each of the selected transceiver optical engines is selected from one of a 100 G transceiver optical engine, a 200 G transceiver optical engine, a 400 G transceiver optical engine, or a 800 G transceiver optical engine.

8. The method of claim 1, further comprising customizing each of the plurality of optical fiber legs based on at least one of end length, number of optical fibers, connector type, or tag requirement.

9. The method of claim 1, further comprising evaluating one or more of fiber operational status, converter component status, or polarity status of the at least a portion of the converter components.

10. The method of claim 1, further comprising packaging the active optical cable in an individual package.

11. A method for assembling an active optical cable, the method comprising:
breaking out a plurality of optical fiber legs from a cable jacket of a fiber optic cable such that the optical fiber legs extend from an end of the cable jacket, wherein each of the optical fiber legs comprises at least one optical fiber;
terminating a plurality of optical fiber pigtails with active connectors;
connecting the active connectors to converter components;
testing the converter components; and
selectively splicing one or more of the optical fiber pigtails to one or more of the optical fiber legs.

12. The method of claim 11, wherein each of the optical fiber legs comprises a buffer tube surrounding the at least one optical fiber of the optical fiber leg.

13. The method of claim 11, wherein each of the optical fiber legs comprises a plurality of optical fibers.

14. The method of claim 11, wherein the selectively splicing step occurs after the testing step.

15. The method of claim 11, wherein the cable jacket is formed from a low smoke zero halogen material.

16. The method of claim 11, wherein the cable jacket has a CMR or CMP rating.

17. The method of claim 11, wherein the converter components are transceiver optical engines.

18. The method of claim 17, further comprising selecting each of the transceiver optical engines, wherein each of the selected transceiver optical engines is selected from one of a 100 G transceiver optical engine, a 200 G transceiver optical engine, a 400 G transceiver optical engine, or a 800 G transceiver optical engine.

19. The method of claim 11, further comprising customizing each of the plurality of optical fiber legs based on at least one of end length, number of optical fibers, connector type, or tag requirement.

20. The method of claim 11, further comprising evaluating one or more of fiber operational status, transceiver optical engine status, or polarity status of the at least a portion of the transceiver optical engines.
